(19) United States
(12) Patent Application Publication
(10) Pub. No.: US 2020/0080391 A1
(43) Pub. Date: Mar. 12, 2020

(54) INTEGRATED FLUIDS MIXING AND DELIVERY SYSTEM

(71) Applicant: Cameron International Corporation, Houston, TX (US)

(72) Inventors: Andrew Marlatt, Houston, TX (US); Vidar Hestad, Kristiansand (NO)

(21) Appl. No.: 16/128,433

(22) Filed: Sep. 11, 2018

(51) Int. Cl. E21B 21/06; E21B 33/14; B28C 7/04

(52) U.S. Cl. CPC E21B 21/062; B28C 7/0481; E21B 33/14

(57) ABSTRACT

An integrated fluids mixing and delivery system includes one or more mixers configured to receive a cement powder and a flow of a mixing liquid, and to mix the cement powder and the flow of the mixing liquid to form a cementing fluid having respective appropriate characteristics for cementing operations. The one or more mixers are also configured to receive a base drilling fluid and a dry component, and to mix the base drilling fluid and the dry component to form a drilling fluid having respective appropriate characteristics for drilling operations.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Natural resources, such as oil and gas, are used as fuel to power vehicles, heat homes, and generate electricity, in addition to various other uses. Once a desired resource is discovered below the surface of the earth, drilling systems are often employed to access the resource. Such systems may include a variety of components, including a mud pumping assembly and a cement pumping assembly, to facilitate drilling operations.

### BRIEF DESCRIPTION OF THE DRAWINGS

Various features, aspects, and advantages of the present disclosure will become better understood when the following detailed description is read with reference to the accompanying figures in which like characters represent like parts throughout the figures, wherein:

FIG. 1 is a schematic diagram of an integrated fluids mixing and delivery system, in accordance with an embodiment of the present disclosure;

FIG. 2 is a schematic diagram of the integrated fluids mixing and delivery system of FIG. 1 during a cement mixing process, in accordance with an embodiment of the present disclosure;

FIG. 3 is a schematic diagram of the integrated fluids mixing and delivery system of FIG. 1 during the cement mixing process and an offline drilling fluid mixing process, in accordance with an embodiment of the present disclosure;

FIG. 4 is a schematic diagram of the integrated fluids mixing and delivery system of FIG. 1 during a drilling fluid mixing process, in accordance with an embodiment of the present disclosure;

FIG. 5 is a perspective view of the integrated fluids mixing and delivery system of FIG. 1, in accordance with an embodiment of the present disclosure; and

FIG. 6 is a schematic diagram of the integrated fluids mixing and delivery system of FIG. 1, in accordance with another embodiment of the present disclosure.

### DETAILED DESCRIPTION OF SPECIFIC EMBODIMENTS

One or more specific embodiments of the present disclosure will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Some existing drilling systems may include a mud pumping assembly and a cement pumping assembly to facilitate drilling operations. The mud pumping assembly may be utilized to pump a drilling fluid (e.g., mud, water-based fluid, oil-based fluid, or synthetic-based fluid) from surface tanks into a drill string. In particular, the mud pumping assembly may pump the drilling fluid from the surface tanks into an interior channel of the drill string, and the drilling fluid may exit the drill string through ports in or near a drill bit that cuts through a subsurface formation to drill a wellbore. The drilling fluid then circulates upwardly through an annulus between an outer surface of the drill string and an inner surface that defines the wellbore. The drilling fluid may lubricate the drill bit, carry formation cuttings toward the surface, and/or maintain hydrostatic pressure within the wellbore, for example.

Once the wellbore has been drilled to a desired depth by the drill bit, the circulation of the drilling fluid is temporarily stopped. Then a section of casing may be advanced into the wellbore, and the cement pumping assembly may be operated to pump a cementing fluid into the wellbore to secure the casing in place within the wellbore. The circulation of the drilling fluid and cementing of the casing within the wellbore may be carried out repeatedly in an alternating manner during drilling operations until a well is completed.

In at least some existing drilling systems, the mud pumping assembly and the cement pumping assembly are physically separate from one another. As a result, the drilling system may include mixing equipment that is underutilized (e.g., not in use for periods of time due to alternating use of the mud pumping assembly and the cement pumping assembly). Furthermore, in at least some existing drilling systems, the mud pumping assembly and the cement pumping assembly are manually controlled and/or are operated independently of one another. Due to the lack of process control and automation, fluid properties of the drilling fluid and/or the cementing fluid may vary, which may negatively affect drilling performance and well integrity, for example.

The mixing processes for drilling fluid and cementing fluid, as well as for various other fluids that may be used at a wellsite, include adding dry and/or liquid components to a base fluid (e.g., base drilling fluid, water, salt water, brine, oleaginous fluids or emulsions thereof). Accordingly, the present embodiments relate to an integrated fluids mixing and delivery system that may be used to mix multiple different types of fluids, including drilling fluid and cementing fluid, at the wellsite. In one embodiment, the integrated fluids mixing and delivery system is used to mix all fluids used by the drilling system, including water-based mud, oil-based mud, cement, spacer fluids, chemical washes, completion fluids, displacement fluids, viscous sweeps, loss circulation treatments, and pills for well kill operations. The present embodiments also relate to methods of using the integrated fluids mixing and delivery system.

The integrated fluids mixing and delivery system may be automated and may adjust mixing parameters based on one or more outputs of one or more sensors, such as density sensors, flow rate sensors, and/or rheology sensors, for example. While the integrated fluids mixing and delivery system may adjust mixing parameters automatically in response to the one or more outputs of the one or more sensors (e.g., without human direction), it should be appreciated that the systems may additionally or alternatively adjust mixing parameters in response to an input by an operator.

The disclosed embodiments may provide various advantages. For example, the integrated fluids mixing and delivery system may be relatively compact and have a smaller footprint compared to existing systems with physically separate mud pumping and cement pumping assemblies. The integrated fluids mixing and delivery system may provide automated control, which in turn may result in more consistent fluid properties and more efficient drilling operations, for example. The integrated fluids mixing and delivery system may also result in lower equipment costs, as well as lower operating costs due to improved efficiency and a reduction in training required for personnel, for example.

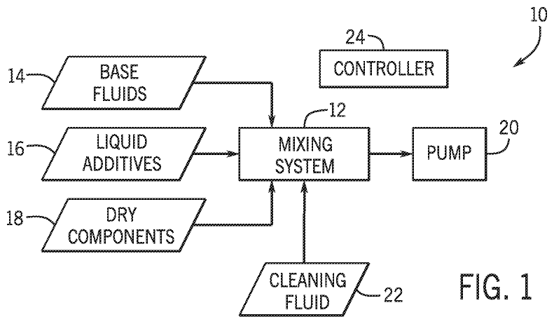

With the foregoing in mind, FIG. 1 is a schematic diagram of an embodiment of an integrated fluids mixing and delivery system 10 that may be used at a wellsite during drilling operations. As shown, the system 10 includes a mixing system 12 that receives and mixes base fluids 14 (e.g., base drilling fluid, water, salt water, brine, oleaginous fluids or emulsions thereof), liquid additives 16, and dry components 18 (e.g., powders, fiber) to form mixed fluids (e.g., various different types of mixed fluids, including drilling fluid and cementing fluid). The mixing system 12 provides the mixed fluids to one or more pumps 20, which pump the mixed fluids into a wellbore. For example, the mixing system 12 may form drilling fluid, and the one or more pumps 20 may pump the drilling fluid into a drill string as a drill bit cuts through a subsurface formation to drill the wellbore. The mixing system 14 may also form cementing fluid, and the one or more pumps 20 may pump the cementing fluid into the wellbore to secure a casing within the wellbore.

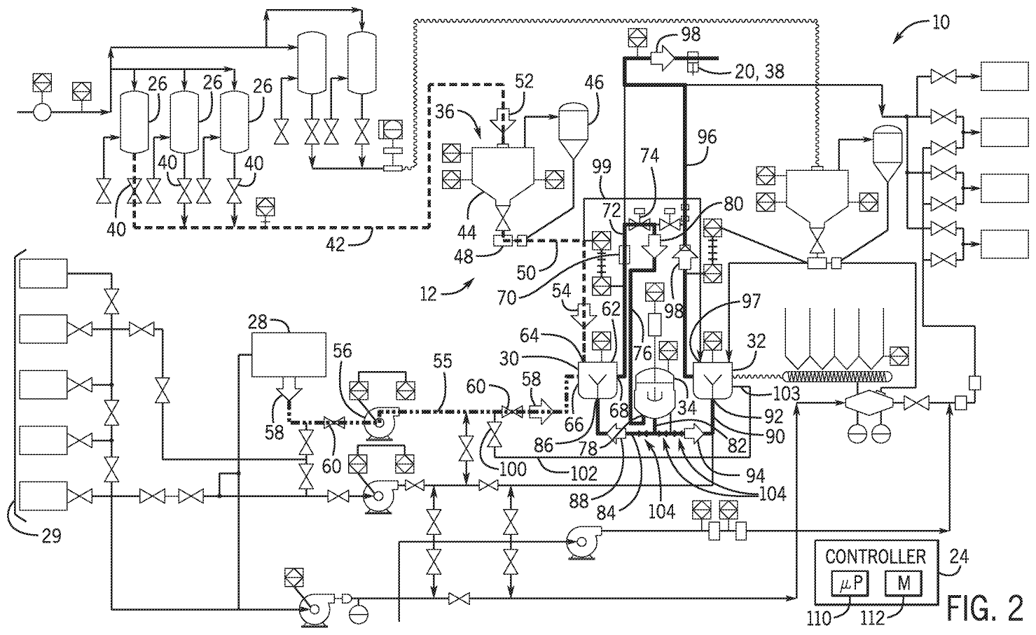

As shown, a cleaning fluid 22 may be provided to the mixing system 12 to clean certain components (e.g., mixers, fluid conduits) of the mixing system 12. Further, a controller 24 (e.g., electronic controller) may control operation of various components (e.g., actuators that adjust valves, conveyors, pumps) within the system 10 to form the mixed fluids via batch or on-the-fly processes. The controller 24 may control the various components based on stored instructions (e.g., predefined combinations of materials), based on sensor feedback (e.g., density and/or rheology of the mixed fluids), and/or based on operator input (e.g., received via an operator interface). In some embodiments, the controller 24 may be integrated into a control system of a drilling rig and may enable an operator to observe and/or control operation of the system 10 from a remote location (e.g., via the operator interface in a control room at the wellsite or at a control center remote from the wellsite). Additional features of the system 10 will be described with references to FIGS. 2-5.

FIG. 2 is a schematic diagram that illustrates an embodiment of the system 10 during a cement mixing process. To carry out the cement mixing process, the system 10 includes one or more cement storage tanks 26 that store and provide a cement powder to the mixing system 12. The system 10 may also include a liquid additives system 28 that stores and provides one or more liquid additives to the mixing system 12. In some embodiments, the liquid additives may be added to a base fluid, such as water, from one or more base fluid tanks 29. The liquid additives and/or the base fluid may form a flow of mixing liquid.

The mixing system 12 may include a first mixer 30 (e.g., primary mixer), a second mixer 32 (e.g., secondary mixer), an averaging tank 34 (e.g., buffer tank), and a surge tank system 36 (e.g., dust separator system) that removes dust from the cement powder. As discussed in more detail below, the mixing system 12 may also include various fluid conduits, conveyors, metering devices, sensors, valves, and pumps. The mixing system 12 mixes the cement powder with the flow of the mixing liquid to form the cementing fluid, which is pumped into the wellbore via the one or more pumps 20, such as a cement pump 38.

More particularly, in operation, the cement powder is released from the one or more cement storage tanks 26 (e.g., via air compressors, gravity, and/or opening one or more valves 40) into a conduit 42 (e.g., pipe) that couples the one or more cement storage tanks 26 to the surge tank system 36. At the surge tank system 36, the cement powder may be held within a surge tank 44 and a cyclone dust collector 46 spins to generate a centrifugal force to draw dust from the cement powder. The cement powder may flow from the surge tank 44 (e.g., via gravity and/or actuating a metering device 48, such as an auger or a valve) into a conveyor 50 (e.g., conduit, pipe, or moving platform) that couples the surge tank 44 to the first mixer 30. The metering device 48 may meter the cement powder to the conveyor 50 at a particular rate (e.g., volumetric flow rate). The flow of the cement powder from the one or more cement storage tanks 26 to the surge tank 44 is shown by flow path and arrow 52, and the flow of the cement powder from the surge tank 44 to the first mixer 30 is shown by flow path and arrow 54.

Additionally, the flow of the mixing liquid with liquid additives and/or base fluid is provided to the first mixer 30. For example, a flow of the mixing liquid may be pumped from the liquid additives system 28 and/or the one or more base fluid tanks 29, through the conduit 55, and into the first mixer 30 via a fluid pump 56, as shown by flow path and arrows 58. Opening various valves, such as one or more valves 60, may also enable and/or adjust the flow of the mixing liquid to the first mixer 30. In this way, both the cement powder and the flow of the mixing liquid may be provided to the first mixer 30.

The first mixer 30 may be any suitable type of mixer, such as an educator mixer or a vortex mixer, which is capable of mixing the cement powder and the flow of the mixing liquid to form a cementing fluid (e.g., cement slurry). During mixing, the first mixer 30 may create a vortex that enhances air separation from the cementing fluid, which facilitates monitoring a solids fraction of the cementing fluid output by the first mixer 30. In the illustrated embodiment, the first mixer 30 includes a tank 62 with an inlet 64 to receive the cement powder and an inlet 66 to receive the flow of the mixing liquid.

Once the cement powder and the flow of the mixing liquid are mixed within the first mixer 30, the cementing fluid is discharged from the tank 62 via an outlet 68. After the cementing fluid is discharged from the tank 62, one or more density sensors 70 (e.g., non-radioactive densitometers) may monitor a solids fraction in the cementing fluid. The one or more density sensors 70 may be positioned along a conduit 72 (e.g., pipe) extending from the outlet 68. If the solids fraction is not appropriate (e.g., for cementing operations in the wellbore), then the cementing fluid may recirculate through the first mixer 30. In particular, the cementing fluid may flow (e.g., through the conduit 72 and a conduit 76 [e.g., pipe] via opening a valve 74) to an inlet 78 of the averaging tank 34, as shown by flow path and arrow 80. The cementing fluid may then flow from the averaging tank 34 via an outlet 82, along a conduit 84 (e.g., pipe), and into an inlet 86 of the first mixer 30, as shown by flow path and arrow 88. Then, additional cement powder and/or additional flow of the mixing liquid may be added to the first mixer 30, and the cementing fluid may again be discharged from the tank 62 via the outlet 68. In this manner, the cementing fluid may be recirculated through the first mixer 30 until the solids fraction is appropriate.

In some embodiments, if the solids fraction measured by the one or more density sensors 70 is appropriate, the cementing fluid may flow from the averaging tank 34 via the outlet 82, along a conduit 90 (e.g., pipe), and into an inlet 92 of the second mixer 32, as shown by flow path and arrow 94. The cementing fluid may then flow from the second mixer 32 to the cement pump 20, 38 via a conduit 96 (e.g., pipe), as shown by flow path and arrows 98. In some embodiments, if the solids fraction measured by the one or more density sensors 70 is appropriate, then the cementing fluid may bypass the averaging tank 34 and the second mixer 32. Instead, the cementing fluid may flow from the first mixer 30 directly to the cement pump 20, 38. This flow path may be utilized at various times, such as when the second mixer 32 and/or the averaging tank 34 are unavailable (e.g., due to non-functioning parts).

As shown in FIG. 2, various other conduits and valves may enable various other mixing processes for the cementing fluid. Thus, the system 10 may provide redundancy and back-up methods of producing the cementing fluid. For example, if the first mixer 30 is unavailable, the cement powder may be directed from the surge tank 44 to an inlet 97 of the second mixer 32, such as via a conveyor 99 (e.g., conduit, pipe, or moving platform). Additionally, the flow of the mixing liquid may be diverted (e.g., via opening the one or more valves 60 and a valve 100) into a conduit 102 (e.g., pipe) to flow to an inlet 103 of the second mixer 32. In this case, the second mixer 32 may mix the cement powder with the flow of the mixing liquid to form the cementing fluid, which can then be recirculated through the averaging tank 34 and/or provided to the cement pump 20, 38.

It should be appreciated that the controller 24 may control the various components of the system 10, such as the pumps (e.g., pump 56), valves (e.g., valves 40, 60, 74, 100), metering devices (e.g., metering device 48), conveyors (e.g., conveyor 50), mixers (e.g., the first mixer 30 and the second mixer 32), in a coordinated manner to facilitate the production of the cementing fluid having the appropriate solids fraction and other properties to cement the casing within the wellbore. The controller 24 may also receive and process signals from the one or more density sensors 70, and the controller 24 may control the various components based on the signals. For example, the controller 24 may control valves 104 downstream of the outlet 82 of the averaging tank 34 based on whether the solids fraction of the cementing fluid is appropriate. The valves 104 may be adjusted (e.g., opened or closed) to direct the cementing fluid back to the first mixer 30 when the solids fraction is not appropriate and to direct the cementing fluid to the second mixer 32 when the solids fraction is appropriate.

The controller 24 may also control these components of the system 10 in a manner that coordinates with the overall drilling operation. For example, the release of the cement powder and the flow of the mixing liquid may be initiated upon receipt of an input (e.g., an operator input at an operator interface, an electronic signal that indicates that the wellbore is at a certain depth) that indicates that cementing operations should commence. In this way, the system 10 may provide automated and controlled mixing and delivery of cementing fluid to the wellbore.

It should also be appreciated that the controller 24 may include one or more processors 110 and one or more memory devices 112. The one or more processors 110 may be used to execute instructions or software, and the one or more memory devices 112 may include a volatile memory, such as random access memory (RAM), and/or a nonvolatile memory, such as ROM. The one or more memory devices 112 may store a variety of information and may be used for various purposes. For example, the one or more memory devices 112 may store processor-executable instructions (e.g., firmware or software) for the one or more processors 110 to execute, such as instructions for processing the signals from the one or more density sensors 70 and controlling various components of the system 10. The one or more memory devices 112 may store data and instructions related to the appropriate parameters for the cementing fluid, desired depth at which cementing operations should commence, and the like.

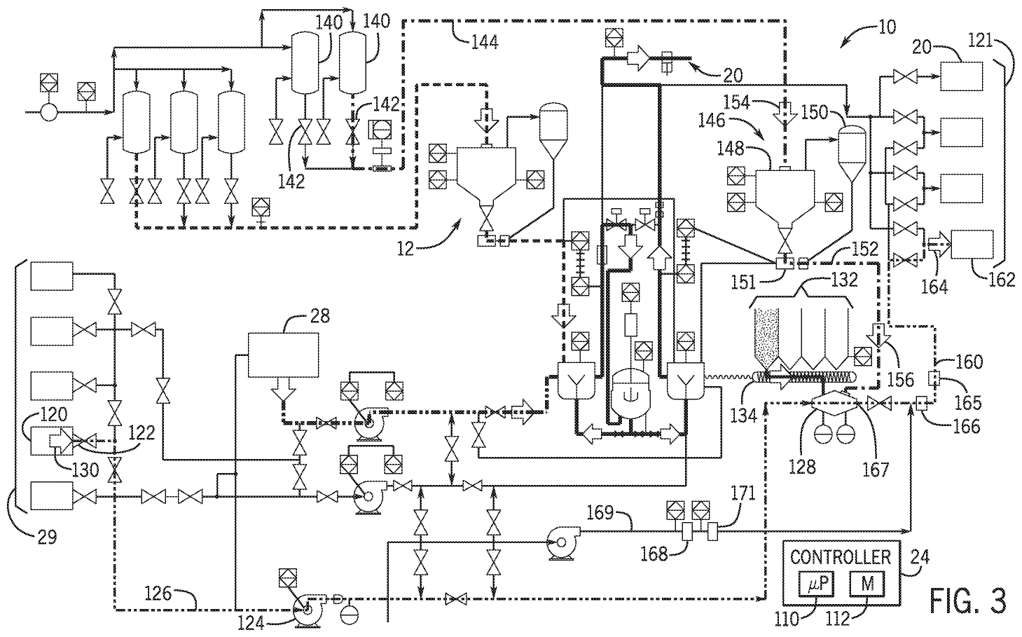

FIG. 3 is a schematic diagram that illustrates an embodiment of the system 10 during the cement mixing process and an offline drilling fluid mixing process. In some embodiments, while the system 10 carries out the cementing mixing process in the manner discussed above with respect to FIG. 2, the system 10 may also (e.g., at the same time, simultaneously) carry out the offline drilling fluid mixing process prepare a drilling fluid. For example, the offline drilling fluid mixing process may mix a base drilling fluid from the one or more base fluid tanks 29, such as a pre-mixed drilling fluid from a drilling fluid tank 120 (e.g., a base drilling fluid tank, a pre-mix tank), with various additives to prepare the drilling fluid. The drilling fluid may then be provided to one or more outlets 121 (e.g., pre-mix tank, pill tank, suction pit, drilling fluid pump). In this manner, the system 10 may more efficiently prepare the drilling fluid for subsequent use in drilling operations (e.g., to pump into the drill string).

More particularly, in operation, a base drilling fluid is released from one or more of the base fluid tanks 29, such as from the drilling fluid tank 120 (e.g., via opening a valve 122 and/or pumping via a fluid pump 124), into a conduit 126 (e.g., pipe). The conduit 126 couples the one or more base fluid tanks 29 to a third mixer 128 (e.g., hopper). The third mixer 128 may be any suitable type of mixer, such as a venturi mixer, that is capable of mixing dry and liquid components to form the drilling fluid. The base drilling fluid may flow from the one or more base fluid tanks 29 to the third mixer 128, as shown by flow path and arrow 130. It should be appreciated that one or more liquid additives from the liquid additive system 28 may be added to the base drilling fluid (e.g., in the conduit 126), and thus, it should be appreciated that the base drilling fluid that is described herein as flowing to the third mixer 128 or to other components downstream of the one or more base fluid tanks 29 may include the one or more liquid additives.

In some embodiments, one or more dry components may be released from one or more dry component storage tanks 132 to a conveyor 134 (e.g., conduit, pipe, or moving platform), which transfers the dry components to the third mixer 128. It should be appreciated that the dry components may be metered from the one or more storage tanks 132 to the conveyor 50 at a particular rate (e.g., volumetric flow rate) via a metering device (e.g., auger or valve), for example. Additionally or alternatively, one or more dry components may be released from one or more dry component storage tanks 140 (e.g., via air compressors, gravity, and/or opening one or more valves 142) into a conduit 144 (e.g., pipe) that couples the one or more dry component storage tanks 140 to a surge tank system 146 (e.g., dust separator system). At the surge tank system 144, the one or more dry components may be supported within a surge tank 148, and a cyclone dust collector 150 may spin to generate a centrifugal force to draw dust from the one or more dry components. The one or more dry components may flow from the surge tank 148 (e.g., via gravity and/or actuating a metering device 150) into a conveyor 152 (e.g., conduit, pipe, or moving platform) that couples the surge tank 148 to the third mixer 128. The metering device 150 may meter the one or more dry components to the conveyor 152 at a particular rate (e.g., volumetric flow rate). The flow of the one or more dry components from the one or more dry component storage tanks 140 to the surge tank 148 is shown by flow path and arrow 154, and the flow of the one or more dry components from the surge tank 148 to the third mixer 128 is shown by flow path and arrow 156. While the illustrated embodiment shows one dry component from one of the dry component storage tanks 140 and one dry component from one of the dry component storage tanks 132, it should be appreciated that any number of dry components from any number of the tanks 132, 140 may be provided to the third mixer 128 simultaneously or sequentially to form the drilling fluid.

The one or more dry components may include barite, bentonite, fibers, or other dry additives that are used to build the drilling fluid with appropriate properties (e.g., rheology, density, chemical composition). In some embodiments, the one or more dry component storage tanks 132 are small tanks that store bentonite, fibers, and/or other dry components, while the one or more dry component storage tanks 140 are large tanks that store bentonite and/or barite. After mixing in the third mixer 128, the drilling fluid (e.g., the base drilling fluid mixed with the one or more liquid additives and/or the one or more dry components) may flow through a conduit 160 (e.g., pipe) to the one or more outlets 121, such as a drilling fluid tank 162 that stores the drilling fluid, as shown by flow path and arrow 164.

In some embodiments, after the drilling fluid is discharged from the third tank 128, one or more density sensors 165 (e.g., non-radioactive densitometers) may monitor a density of the drilling fluid and/or one or more rheology sensors 166 (e.g., rheometers) may monitor rheological properties (e.g., viscosity, viscoelasticity) of the drilling fluid. The one or more density sensors 165 and/or the one or more rheology sensors 166 may be positioned along the conduit 160 extending from an outlet 167 of the third mixer 128. In some embodiments, one or more density sensors 171 and/or one or more rheology sensors 168 may be positioned along a sampling line 169 (e.g., conduit or pipe) to monitor density and rheological properties of the base drilling fluid (e.g., with or without the one or more liquid additives), respectively.

It should be appreciated that the controller 24 may control the various components of the system 10 illustrated in FIG. 3, such as the pumps (e.g., pump 124), valves (e.g., valves 122, 142), metering devices (e.g., metering device 150), conveyors (e.g., conveyors 134, 150), mixers (e.g., the third mixer 128), in a coordinated manner that enables the production of the drilling fluid having the appropriate properties. The controller 24 may also receive and process signals from the one or more density sensors 165, 171 and/or the one or more rheology sensors 166, 168, and the controller 24 may control the various components based on the signals. For example, the controller 24 may control the type and/or quantity (e.g., flow rate) of the one or more dry components provided to the third mixer 128 based on the density and/or rheological properties of the drilling fluid and/or the base drilling fluid to achieve the drilling fluid having the appropriate parameters. The controller 24 may also control these components of the system 10 in a manner that coordinates with the overall drilling operation. For example, the flow of the drilling fluid from the one or more base fluid tanks 29 and the release of the one or more dry components from the one or more dry component storage tanks 132, 140 may be initiated upon receipt of an input (e.g., an operator input at a user interface) and/or in response to initiation of the cement mixing process. In this way, the system 10 may provide automated, controlled, and efficient mixing of drilling fluid while the cementing fluid is being mixed and delivered to the wellbore via other components of the system 10.

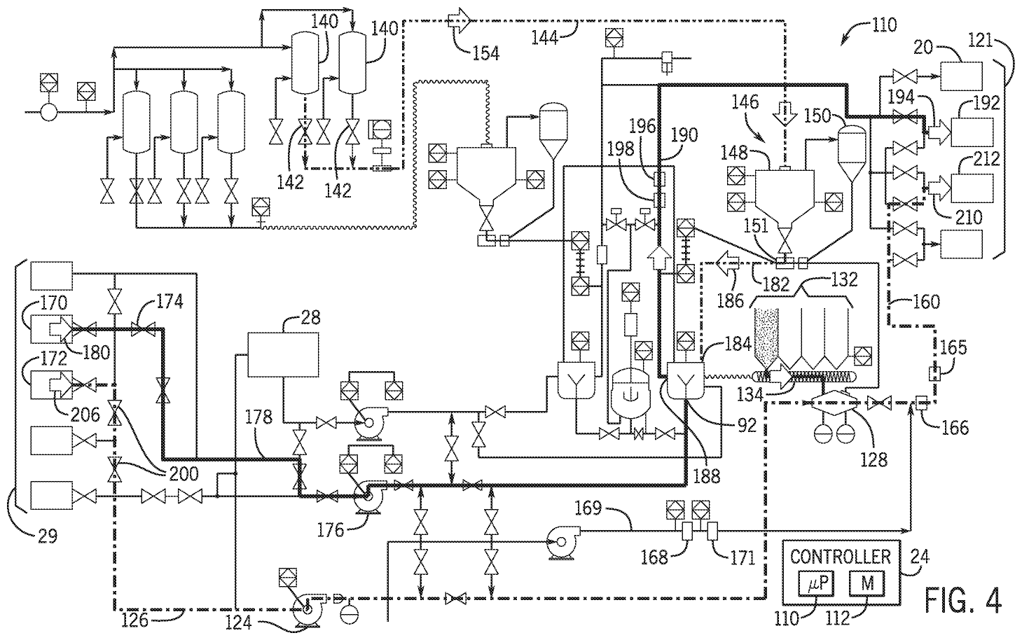

FIG. 4 is a schematic diagram that illustrates an embodiment of the system 10 during a drilling fluid mixing process. During the drilling mud mixing process, the system 10 does not carry out the cement mixing process discussed above with respect to FIG. 2. The drilling fluid mixing process may include modifying a base drilling fluid (e.g., a pre-mixed drilling fluid) from the one or more base fluid tanks 29, such as a drilling fluid tank 170 (e.g., frac tank) and/or a drilling fluid tank 172 (e.g., pill tank). The drilling fluid mixing process may include modifying base drilling fluids from multiple different sources (e.g., the drilling fluid tanks 170, 172) at the same time (e.g., simultaneously) and/or provide different drilling fluids (e.g., having different properties) to multiple different outlets 121, which may provide for efficient drilling operations. While the second mixer 32 is utilized to mix the drilling fluid in FIG. 4, it should be appreciated that any of the mixers (e.g., the first mixer 30 and/or the second mixer 32) may be utilized to mix the drilling fluid.

In the illustrated embodiment, a base drilling fluid is released from the drilling fluid tank 170 (e.g., via opening a valve 174 and/or pumping via a fluid pump 176) into a conduit 178 (e.g., pipe). In some embodiments, one or more liquid additives from the liquid additives system 28 are added to the base drilling fluid (e.g., in the conduit 178), and thus, it should be appreciated the base drilling fluid that is described herein as flowing to the second mixer 32 or to other components downstream of the one or more base fluid tanks 29 may include the one or more liquid additives. The conduit 178 couples the drilling fluid tank 170 to the inlet 92 of the second mixer 32. The base drilling fluid may flow from the drilling fluid tank 170 to the second mixer 32, as shown by flow path and arrow 180.

Additionally, one or more dry components may be released from one or more dry component storage tanks 140 (e.g., via gravity and/or opening one or more valves 142) into the conduit 144 that couples the one or more dry component storage tanks 140 to the surge tank system 146. At the surge tank system 144, the one or more dry components may be supported within the surge tank 148 while the cyclone dust collector 150 removes dust. The one or more dry components may then flow from the surge tank 148 (e.g., via gravity and/or actuating the metering device 150) into a conveyor 182 (e.g., conduit, pipe, or moving platform) that couples the surge tank 148 to an inlet 184 of the second mixer 32. The metering device 150 may meter the one or more dry components to the conveyor 182 at a particular rate (e.g., volumetric flow rate). The flow of the one or more dry components from the one or more dry component storage tanks 140 to the surge tank 148 is shown by flow path and arrow 154, and the flow of the one or more dry components from the surge tank 148 to the second mixer 32 is shown by flow path and arrow 186.

The base drilling fluid from the drilling fluid tank 170 and the one or more dry components from the one or more dry component storage tanks 140 may be mixed within the second mixer 32. The drilling fluid (e.g., the base drilling fluid mixed with the one or more liquid additives and/or the one or more dry components) may then flow from an outlet 188 of the second mixer 32 into a conduit 190 (e.g., pipe) that couples the second mixer 32 to the one or more outlets 121, such as a suction pit 192. The flow of the drilling fluid from the second mixer 32 to the suction pit 192 is shown by flow path and arrow 194. In some embodiments, after the drilling fluid is discharged from the second tank 32, one or more density sensors 196 (e.g., non-radioactive densitometers) may monitor a density of the drilling fluid and/or one or more rheology sensors 198 (e.g., rheometers) may monitor rheological properties (e.g., viscosity, viscoelasticity) of the drilling fluid.

In some embodiments, a separate process may be carried out at the same time to create a different drilling fluid (e.g., a pill or a quantity of drilling fluid having different characteristics and composition), which may be utilized for specific tasks during drilling operations. For example, as shown, a base drilling fluid may be released from the drilling fluid tank 172 (e.g., via opening valves 200 and/or pumping via a fluid pump 124) into the conduit 126. The conduit 126 couples the drilling fluid tank 172 to the third mixer 128. The base drilling fluid may flow from the drilling fluid tank 172 to the third mixer 128, as shown by flow path and arrow 206. It should be appreciated that one or more liquid additives from the liquid additive system 28 may be added to the base drilling fluid (e.g., in the conduit 126), and thus, it should be appreciated that the base drilling fluid that is described herein as flowing to the third mixer 128 or to other components downstream of the one or more base fluid tanks 29 may include the one or more liquid additives.

Additionally, one or more dry components may be released from one or more dry component storage tanks 132 into the conveyor 134, which transfers the dry components to the third mixer 128. It should be appreciated that the dry components may be metered from the one or more storage tanks 132 to the conveyor 134 at a particular rate (e.g., volumetric flow rate) via a metering device, for example. After mixing in the third mixer 128, the drilling fluid (e.g., the base drilling fluid mixed with the one or more liquid additives and/or the one or more dry components) may flow through the conduit 160 to a drilling fluid tank, such as a drilling fluid tank 212 (e.g., pill tank) that stores the drilling mud, as shown by flow path and arrow 210.

It should be appreciated that the controller 24 may control the various components of the system 10 illustrated in FIG. 4, such as the pumps (e.g., pump 124, 176), valves (e.g., valves 142, 174, 200), metering devices (e.g., metering device 150), conveyors (e.g., conveyors 134, 150, 182), mixers (e.g., the second mixer 32 and the third mixer 128), in a coordinated manner that enables the production of the drilling fluid having the appropriate properties. The controller 24 may also receive and process signals from the one or more density sensors 165, 167, 196 and/or the one or more rheology sensors 166, 168, 198, and the controller 24 may control the various components based on the signals. For example, the controller 24 may control the type and/or quantity (e.g., flow rate) of the one or more dry components provided to the third mixer 128 based on the density and/or rheological properties of the drilling fluid and/or the base drilling fluid to achieve the drilling fluid having the appropriate parameters. The controller 24 may also control these components of the system 10 in a manner that coordinates with the overall drilling operation. For example, the flow of the drilling fluid from the drilling fluid tanks 170, 172 and the release of the one or more dry components may be initiated upon receipt of an input (e.g., an operator input at a user interface), in response to an end of the cement mixing process, and/or in response to an end of a cleaning process that is carried out between the cement mixing process and the drilling mud mixing process. In this way, the system 10 may provide automated, controlled, and efficient mixing and delivery of drilling fluid using the same system that mixes and delivers the cementing fluid.

With reference to FIGS. 2-4, it can be seen that the controller 24 controls and coordinates operation of various components that are used to generate the cementing fluid and the drilling fluid for the well. In addition to the exemplary sensors illustrated in FIGS. 2-4 and discussed above, it should be appreciated that additional density sensors and/or rheology sensors may be positioned at various locations of the system 10. Furthermore, one or more flow sensors (e.g., flow meters) may be positioned at various locations of the system 10 to monitor a flow rate of a respective liquid, slurry, or dry component. In some embodiments, the pumps disclosed herein (e.g., pumps 56, 124, 176) may be configured to pump the respective fluids (e.g., the flow of the mixing liquid or the base fluids) at variable flow rates. In some embodiments, the pumps may include or be associated with respective flow sensors (e.g., along conduits 55, 126, 178) to monitor the flow rates.

Automated control loops may use data from one or more sensors (e.g., sensors 70, 165, 166, 167, 168, 196, 198 and flow sensors) to mix the various fluids to meet predefined parameters (e.g., density, rheology, chemical composition), which may be stored in the memory 112, for example. In some embodiments, a first control loop is governed by the output of the one or more sensors. In particular, in the cement mixing process, a fixed input may include the flow of the mixing liquid (e.g., the one or more liquid additives and/or the base fluid) metered via the pump 56, and the adjustable input may include the cement powder that is metered via the metering device 48 to produce the cementing fluid having the predefined parameters. In some embodiments, this control loop may adjust both the flow rate of the mixing liquid and the flow rate of the cement powder to achieve the predefined parameters for the cementing fluid and/or to maintain a suitable level of the cementing fluid within the averaging tank 34 (e.g., monitored via a level sensor, which provides feedback to the controller 24).

In the drilling fluid mixing process, a fixed input may include the flow of the base drilling fluid metered via the pumps 124, 176, and the adjustable input may include the one or more dry components from the one or more dry component storage tanks 132, 140 metered via metering devices (e.g., the metering device 150) to produce the drilling fluid having the predefined parameters. In some embodiments, this control loop may adjust both the flow rate of the base drilling fluid and the flow rate of the one or more dry components to achieve the predefined parameters for the drilling fluid and/or to maintain a suitable level at the one or more outlets 121.

During the cement mixing process and the drilling fluid mixing process, a second control loop is utilized to prepare the liquid component, such as the flow of the mixing liquid for the cement mixing process or the base drilling fluid for the drilling fluid mixing process. For example, a base fluid, such as water, may be pumped from the one or more base fluid tanks 29 to the conduit 55 at a particular flow rate. One or more liquid additives from the liquid additive system 28 may be added continuously to the conduit 55 at predefined concentrations. The flows of the base fluid and the one or more liquid additives may be controlled to provide a particular flow rate appropriate for the first control loop. The controller 24 may also be configured to automate pressure testing (e.g., tests of operational integrity of piping and hoses, blowout preventers tests, leak off tests, formation integrity tests, casing integrity tests) during various stages of the drilling process, including control, monitoring, and recording of pressure testing data.

Furthermore, as shown in FIGS. 2-4, certain components are used to mix and/or deliver both the cementing fluid and the drilling fluid. For example, in the illustrated embodiment, the second mixer 32 receives and mixes mix both the cementing fluid and the drilling fluid at different times during drilling operations. Additionally, a portion of the conduits 96, 190 extending from the outlet 188 of the second mixer 32 is utilized to transport the cementing fluid and the drilling fluid at different times during drilling operations. As noted above, the first mixer 30, the second mixer 32, or both (and associated conduits) may be utilized to mix and deliver both the cementing fluid and the drilling fluid.

However, the system 10 is designed to maintain separation between the cementing fluid and the drilling fluid in other ways to minimize cleaning operations and/or to block unwanted mixing between the cementing fluid and the drilling fluid. Because entry of drilling fluid into cementing fluid can interfere in cementing operations, and because entry of cementing fluid into drilling fluid can interfere in drilling operations, it is desirable for the system 10 to provide some separation between these fluids. Accordingly, the system 10 includes a separate fluid path and equipment (e.g., the conduit 55 and the pump 56) for the flow of the mixing liquid to the inlet 66 of the first mixer 30, a separate fluid path and equipment (e.g., the conduit 126 and the pump 124) for the flow of drilling fluid to the third mixer 128, and a separate fluid path and equipment (e.g., the conduit 178 and the pump 176) for the flow of drilling fluid to the inlet 92 of the second mixer 32.

It should be appreciated that the cleaning fluid may be provided to various portions of the system 10 prior to initiating the cement mixing process of FIG. 2 and prior to initiating the drilling mud mixing process of FIG. 4. Due to the design of the system 10, the cleaning may be limited to only a few components (e.g., to clean the conduit 90, the second mixer 32, the portion of the conduits 96, 190), thereby enabling efficient cleaning processes and transition between the cement mixing process of FIG. 2 and the drilling mud mixing process of FIG. 4.

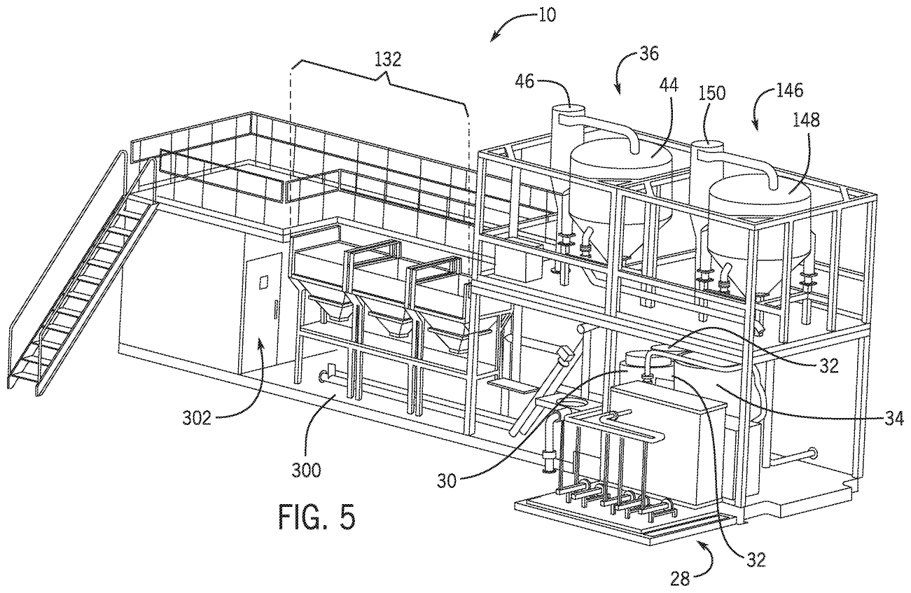

FIG. 5 is a perspective view of the system 10, in accordance with an embodiment of the present disclosure. As shown, the system 10 includes a skid 300 that supports the liquid additive system 28, the first mixer 30, the second mixer 32, the averaging tank 34, the surge tank system 36 having the surge tank 44 and the cyclone dust collector 46, the surge tank system 146 having the surge tank 148 and the cyclone dust collector 150, and the one or more dry component storage tanks 132. Other components, such as the one or more cement storage tanks 26, the one or more dry component storage tanks 140, and the various drilling fluid tanks, may be supported at other locations proximate to the skid 300. The controller 24 may be located in a control room 302 supported on the skid 300; however, it should be appreciated that the controller 24 may be located at another location at the wellsite or at a location remote from the wellsite.

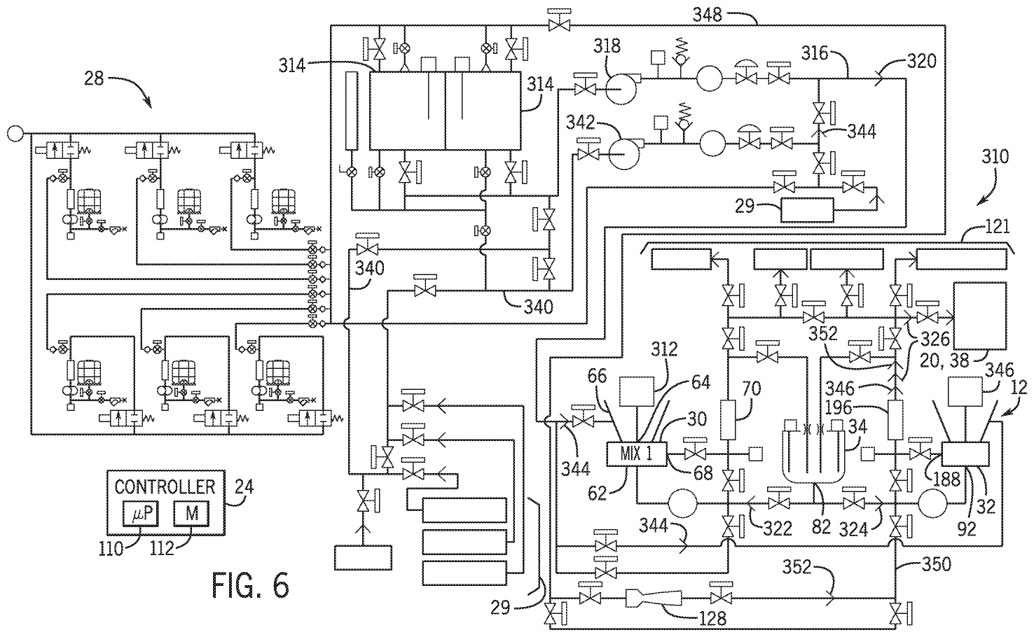

It should be appreciated that the integrated fluids mixing and delivery system 10 disclosed herein may have various configurations. For example, FIG. 6 is a schematic diagram of another embodiment of the integrated fluids mixing and delivery system 10. As shown, the system 10 includes a cement powder delivery system 312, which may include the one or more cement storage tanks 26 and/or the surge tank system 36 shown and described above with respect to FIG. 2. The system 10 may also include the liquid additives system 28 that stores and provides one or more liquid additives to the mixing system 12, which includes the first mixer 30, the second mixer 32, and the averaging tank 34. The system 10 may also include one or more mix water tanks 314 that receive and mix the one or more liquid additives and a base fluid, such as water, thereby forming a flow of mixing liquid.

In operation, the cement powder and the flow of the mixing liquid are provided to the first mixer 30. For example, the cement powder may be provided to the first mixer 30 via the cement powder delivery system 312. Additionally, the flow of the mixing liquid may be pumped into the first mixer 30 through a conduit 316 via a pump 318, as shown by arrow 320. Various valves may be opened and closed to enable and/or adjust the flow of the mixing liquid to the first mixer 30. As shown, the first mixer 30 includes the tank 62 with the inlet 64 to receive the cement powder and the inlet 66 to receive the flow of the mixing liquid.

Once the cement powder and the flow of the mixing liquid are mixed within the first mixer 30, the cementing fluid is discharged from the tank 62 via the outlet 68. After the cementing fluid is discharged from the tank 62, one or more density sensors 70 may monitor a solids fraction in the cementing fluid. If the solids fraction is not appropriate (e.g., for cementing operations in the wellbore), then the cementing fluid may recirculate through the first mixer 30 via the averaging tank 34, as shown by arrow 322.

In some embodiments, if the solids fraction measured by the one or more density sensors 70 is appropriate, the cementing fluid may flow from the averaging tank 34 via the outlet 82 and into the inlet 92 of the second mixer 32, as shown by arrow 324. The cementing fluid may then flow from the second mixer 32 to the cement pump 20, 38, as shown by arrows 326. In some embodiments, if the solids fraction measured by the one or more density sensors 70 is appropriate, then the cementing fluid may bypass the averaging tank 34 and the second mixer 32. Instead, the cementing fluid may flow from the first mixer 30 directly to the cement pump 20, 38. This flow path may be utilized at various times, such as when the second mixer 32 and/or the averaging tank 34 are unavailable (e.g., due to non-functioning parts).

As shown in FIG. 6, various other conduits and valves may enable various other mixing processes for the cementing fluid. Thus, the system 10 may provide redundancy and back-up methods of producing the cementing fluid. Furthermore, it should be appreciated that the controller 24 may control the various components of the system 10, such as the pumps (e.g., pump 318), valves, mixers (e.g., the first mixer 30 and the second mixer 32), in a coordinated manner to facilitate the production of the cementing fluid having the appropriate solids fraction and other properties to cement the casing within the wellbore. The controller 24 may also receive and process signals from the one or more density sensors 70, and the controller 24 may control the various components based on the signals.

The system 10 of FIG. 6 may also be used to prepare a drilling fluid. The drilling fluid mixing process may include modifying a base drilling fluid from the one or more base fluid tanks 29. In the illustrated embodiment, a base drilling fluid is released from the one or more base fluid tanks 29 into one or more conduits 340. In some embodiments, one or more liquid additives from the liquid additives system 28 and/or the flow of the mixing liquid from the one or more mix water tanks 314 are added to the base drilling fluid, such as in the one or more conduits 340. Thus, it should be appreciated that the base drilling fluid that is described herein as flowing to the second mixer 32 or to other components downstream of the one or more base fluid tanks 29 may include the one or more liquid additives. The base drilling fluid may then be pumped from the one or more base fluid tanks 29 to the second mixer 32 via a pump 342, as shown by arrows 344.

Additionally, one or more dry components may be released from a dry component delivery system 346, which may include one or more dry component storage tanks 140 and/or the surge tank system 146. The base drilling fluid and the one or more dry components may be mixed within the second mixer 32. The drilling fluid (e.g., the base drilling fluid mixed with the one or more liquid additives and/or the one or more dry components) may then flow from the outlet 188 of the second mixer 32 to the one or more outlets 121, as shown by arrow 346.

In some embodiments, after the drilling fluid is discharged from the second tank 32, one or more density sensors 196 may monitor a density of the drilling fluid. It should be appreciated that one or more rheology sensors may be provided to monitor rheological properties (e.g., viscosity, viscoelasticity) of the drilling fluid. While the second mixer 32 is utilized to mix the drilling fluid in FIG. 6, it should be appreciated that one or both of the mixers (e.g., the first mixer 30 and/or the second mixer 32) may be utilized to mix the drilling fluid. In some embodiments, during the drilling mud mixing process, the system 10 does not carry out the cement mixing process, as the second mixer 32 is utilized to form the drilling fluid and cannot be utilized to form the cementing fluid.

In some embodiments, at different times, a different process may be carried out to create a drilling fluid (e.g., a pill or a quantity of drilling fluid having different characteristics and composition), which may be utilized for specific tasks during drilling operations. For example, a base drilling fluid may be released from the one or more base fluid tanks 29 to the third mixer 128 (e.g., via one or more conduits). Additionally, one or more liquid additives from the liquid additives system 28 and/or the flow of the mixing liquid from the one or more mix water tanks 314 are provided to the third mixer 128 (e.g., via a conduit 348), and/or one or more dry components from the dry component delivery system 346 may be provided to the third mixer 128 (e.g., via one or more conduits). After mixing in the third mixer 128, the drilling fluid (e.g., the base drilling fluid mixed with the one or more dry components) may flow through a conduit (e.g., conduit 350) to the one or more outlets 121, as shown by arrows 352. In some embodiments, the system 10 may be adapted to prepare the cementing fluid in the manner discussed above and to prepare the drilling fluid via the third mixer 128 simultaneously. For example, an additional, independent conduit may extend directly from the third mixer 128 to the one or more outlets 121.

It should be appreciated that the controller 24 may control the various components of the system 10 illustrated in FIG. 4, such as the pumps (e.g., pump 342), valves, mixers (e.g., the second mixer 32 and/or the third mixer 128), in a coordinated manner that enables the production of the drilling fluid having the appropriate properties. The controller 24 may also receive and process signals from the one or more density sensors 196 and/or one or more rheology sensors, and the controller 24 may control the various components based on the signals. Furthermore, automated control loops may use data from one or more sensors (e.g., sensors 70, 196, flow sensors, and other sensors) to mix the various fluids to meet predefined parameters (e.g., density, rheology, chemical composition), which may be stored in the memory 112, for example. Similar to the system 10 of FIGS. 1-5, certain components of the system 10 are used to mix and/or deliver both the cementing fluid and the drilling fluid. For example, in the illustrated embodiment, the second mixer 32 receives and mixes mix both the cementing fluid and the drilling fluid at different times during drilling operations. However, the system 10 is designed to maintain separation between the cementing fluid and the drilling fluid in other ways to minimize cleaning operations and/or to block unwanted mixing between the cementing fluid and the drilling fluid.

While the disclosure may be susceptible to various modifications and alternative forms, specific embodiments have been shown by way of example in the drawings and have been described in detail herein. However, it should be understood that the disclosure is not intended to be limited to the particular forms disclosed. Rather, the disclosure is to cover all modifications, equivalents, and alternatives falling within the spirit and scope of the disclosure as defined by the following appended claims. For example, while the disclosure provides examples of mixing dry and liquid components to form cementing fluid and drilling fluid, it should be appreciated that the system 10 may be mix dry and liquid components to form any of a variety of fluids for any operations. Furthermore, variations in the circuit and arrangement of components (e.g., tanks, conduits, valves, pumps) may vary, but still provide integrated mixing and delivery of different fluids in the manner disclosed herein. It should also be appreciated that any features disclosed with respect to FIGS. 1-6 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An integrated fluids mixing and delivery system, comprising:
one or more mixers configured to:
receive a cement powder and a flow of a mixing liquid;
mix the cement powder and the flow of the mixing liquid to form a cementing fluid having respective appropriate characteristics for cementing operations;
receive a base drilling fluid and a dry component; and
mix the base drilling fluid and the dry component to form a drilling fluid having respective appropriate characteristics for drilling operations.

2. The system of claim 1, wherein the one or more mixers comprises a single mixer comprising a single mixing tank that is utilized to mix the cement powder and the flow of the mixing liquid to form the cementing fluid and to mix the base drilling fluid and the dry component to form the drilling fluid.

3. The system of claim 1, wherein the mixing system comprises a first mixer and a second mixer, the first mixer and the second mixer are utilized to mix the cement powder and the flow of the mixing liquid to form the cementing fluid during cementing operations, and the second mixer is utilized to mix the base drilling fluid and the dry component to form the drilling fluid during drilling operations.

4. The system of claim 3, wherein the first mixer is isolated from the base drilling fluid and the dry component.

5. The system of claim 3, comprising a third mixer, wherein the third mixer is configured to receive a second base drilling fluid and a second dry component, and to mix the second base drilling fluid and the second dry component to form a second drilling fluid while the first mixer and the second mixer mix the cement powder and the flow of the mixing liquid to form the cementing fluid during the cementing operations.

6. The system of claim 1, comprising a liquid additives system and one or more base fluid tanks, wherein one or more liquid additives from the liquid additives system and one or more base fluids from the base fluid tanks combine to form the flow of the mixing liquid.

7. The system of claim 1, comprising one or more surge tank systems configured to separate dust from the cement powder, the dry component, or both.

8. The system of claim 1, comprising a controller configured to control components of the system to adjust respective flow rates of the cement powder, the flow of the mixing liquid, the base drilling fluid, and the dry component to the one or more mixers.

9. The system of claim 8, comprising one or more sensors, wherein the controller is configured to adjust the respective flow rates based on data received from the one or more sensors.

10. The system of claim 1, wherein the flow of the mixing liquid flows through a first conduit to the one or more mixers and a flow of the base drilling fluid flows through a second conduit to the one or more mixers, and the first conduit and the second conduit are separate and isolated from one another.

11. The system of claim 1, comprising a cleaning system configured to provide a cleaning fluid to portions of the system that contact both the cementing fluid and the drilling fluid.

12. The system of claim 1, wherein the one or more mixers comprises a first mixer that is utilized to mix the cement powder and the flow of the mixing liquid to form the cementing fluid during cementing operations, a second mixer that is utilized to mix the base drilling fluid and the dry component to form the drilling fluid during drilling operations, and a third mixer that is utilized to mix a second base drilling fluid and a second dry component to form a second drilling fluid during both the cementing operations and the drilling operations.

13. An integrated fluids mixing and delivery system for a drilling system, comprising:
a controller configured to:
control a flow of a first dry component and a flow of a first liquid to a first mixer;
control mixing of the first dry component and the first liquid in the first mixer and a second mixer to form a first fluid having respective predefined characteristics;
control a flow of a second dry component and a flow of a second liquid to the second mixer; and
control mixing of the second dry component and the second liquid in the second mixer to form a second fluid having respective predefined characteristics.

14. The system of claim 13, wherein the first dry component comprises a cement powder, the first liquid comprises a mixing liquid comprising a liquid additive and a base fluid, the first fluid comprises a cementing fluid configured to cement a casing within a wellbore, the second dry component comprises a dry additive, and the second liquid comprises a base drilling fluid, and the second fluid comprises a drilling fluid configured to facilitate drilling operations.

15. The system of claim 13, wherein the controller is configured to control a flow of a third dry component and a third liquid to a third mixer, and to control mixing of the third dry component and the third liquid in the third mixer to form a third fluid having respective predefined characteristics.

16. The system of claim 13, comprising one or more sensors, wherein the controller is configured to control the flow of the first dry component, the flow of the first liquid, the flow of the second dry component, and the flow of the second liquid based on data received from the one or more sensors.

17. The system of claim 13, wherein the controller is configured to control the flow of the first dry component, the flow of the first liquid, the flow of the second dry component, and the flow of the second liquid to alternatingly utilize the second mixer to mix the first dry component and the first liquid to form the first fluid during cementing operations and to utilize the second mixer to mix the second dry component and the second liquid to form the second fluid during other operations.

18. The system of claim 13, wherein the controller is configured to receive an operator input and to control the flow of the first dry component, the flow of the first liquid, the flow of the second dry component, and the flow of the second liquid based on the operator input.

19. A method of operating an integrated fluids mixing and delivery system, comprising:
receiving, at a first mixer, a cement powder and a flow of a mixing liquid;
mixing, using the first mixer and a second mixer, the cement powder and the flow of the mixing liquid to form a cementing fluid having respective appropriate characteristics for cementing operations;
receiving, at the second mixer, a base drilling fluid and a dry component; and
mixing, using the second mixer, the base drilling fluid and the dry component to form a drilling fluid having respective appropriate characteristics for drilling operations.

20. The method of claim 19, comprising:
receiving, at a third mixer, a second base drilling fluid and a second dry component; and
mixing, using the third mixer, the second base drilling fluid and the second dry component to form a second drilling fluid having respective appropriate characteristics for drilling operations;
wherein the third mixer forms the second drilling fluid while the first mixer and the second mixer form the cementing fluid during cementing operations and while the second mixer forms the drilling fluid during drilling operations.
